(19) United States
(12) Patent Application Publication
(10) Pub. No.: US 2024/0281885 A1
(43) Pub. Date: Aug. 22, 2024

(54) SYSTEMS AND METHODS FOR CONVEX-OPTIMIZATION BASED DECUMULATION COMPUTATION

(71) Applicant: BlackRock, Inc., New York, NY (US)

(72) Inventors: Steven Diamond, New York, NY (US); Shane Barratt, Palo Alto, CA (US); Nicholas Moehle, Palo Alto, CA (US); Mykel J. Kochenderfer, Palo Alto, CA (US); Stephen Boyd, Palo Alto, CA (US)

(21) Appl. No.: 18/545,895

(22) Filed: Dec. 19, 2023

Related U.S. Application Data
(63) Continuation of application No. 17/565,080, filed on Dec. 29, 2021, now abandoned.
(60) Provisional application No. 63/213,080, filed on Jun. 21, 2021.

(51) Int. Cl. G06Q 40/06; G06Q 40/08; G06Q 40/10

(52) U.S. Cl. CPC G06Q 40/06; G06Q 40/08; G06Q 40/10

(57) ABSTRACT

Embodiments described herein provide a timeline-based decumulation management mechanism for wealth management in retirement. The mechanism incorporates a plurality of factors and constraints including a desired consumption and bequeath, investment in qualified and nonqualified accounts, account disbursement and conversion rules, income and capital gains taxes, tracking of tax lots, estate tax rules such as basis step-up, Social Security, pensions, real estate, mortgages, SPIA and deferred income annuities, term life insurance, and alternatives. Specifically, the mechanism translates various account information into one or more convex constraints over a consumption variable, an income variable, a taxable income variable, and a bequest variable at the current year. Subject to these convex constraints, the mechanism is able to formulate a convex optimization problem that maximizes a utility representing the lifetime expectation of assets.

### CROSS REFERENCE(S)

The present disclosure is a nonprovisional of and claims priority under 35 U.S.C. 119 to U.S. provisional application No. 63/213,080, filed on Jun. 21, 2021, which is hereby expressly incorporated by reference herein in its entirety.

### TECHNICAL FIELD

The present disclosure relates generally to financial data collection and processing, and more specifically, to systems and methods for managing an asset portfolio based on a timeline-based decumulation strategy.

### BACKGROUND

Existing wealth management systems often compute recommended buy or sell positions at the current time to maximize the portfolio return at a given time point in the future. Individualized wealth management in the long term, however, often includes complex factors rather than maximizing the current investment return. For example, in the United States, wealth management can often be closely tied to retirement planning, thus involving variables such as tax advantaged accounts such as individual retirement account (IRA), health saving account (HSA), and/or the like. These accounts can only be operated according to strict regulatory limits and thus add complexity to the existing wealth management optimization problem.

### BRIEF DESCRIPTION OF THE DRAWINGS

FIG. 1 is a simplified diagram illustrating an example of timeline-based decumulation strategy planning, according to some embodiments described herein.

FIG. 2 is a simplified diagram illustrating a server interacting with various entities to generate the decumulation strategy described in FIG. 1, according to some embodiments described herein.

FIG. 3 is a simplified diagram illustrating a network system implementing the server and other entities described in FIG. 2, according to some embodiments described herein.

FIG. 4 is a simplified diagram illustrating formulating a lifetime optimization problem with convex line item constraints representing various account dynamics, according to some embodiments described herein.

FIG. 5 is a simplified workflow diagram illustrating a method for generating a timeline-based asset portfolio decumulation plan, according to some embodiments described herein.

FIG. 6 is a simplified diagram illustrating an objective of the optimization problem described in FIG. 4, according to some embodiments described herein.

FIG. 7 is a simplified diagram illustrating a computing device used to implement the server and/or other entities described in FIGS. 1-6, according to some embodiments described herein.

In the figures and appendices, elements having the same designations have the same or similar functions.

### DETAILED DESCRIPTION

Embodiments described herein provide a timeline-based decumulation management mechanism for wealth management in retirement. The mechanism incorporates a plurality of factors and constraints including a desired consumption and bequeath, investment in qualified and nonqualified accounts, account disbursement and conversion rules, income and capital gains taxes, tracking of tax lots, estate tax rules such as basis step-up, Social Security, pensions, real estate, mortgages, SPIA and deferred income annuities, term life insurance, and alternatives. Specifically, the mechanism translates various account information into one or more convex constraints over a consumption variable, an income variable, a taxable income variable, and a bequest variable at the current year. Subject to these convex constraints, the mechanism is able to formulate a convex optimization problem that maximizes a utility representing the lifetime expectation of assets.

For example, an input of values of a retiree's brokerage, IRA, and Roth IRA accounts, their Social Security income, and one or more forecasts of market returns for the next 40 years may be input to an optimizer. Lot-level data for the brokerage account may also be included. The optimizer may generate an output in the form of a complete financial plan over the next 40 years. The plan gives how much to withdraw (or deposit) from each account (and for the brokerage account, which lots to sell); how much to transfer among accounts (respecting the rules, of course), how much (if any) of annuity and term life insurance to purchase each year, and a target consumption amount. To achieve this, the mechanism forms a very large convex optimization problem entailing the various account information into convex constraints in order to suggest current actions for the retiree, such as consumption level, account withdrawals, transfers between accounts, and which tax lots to sell, and/or the like.

In one embodiment, model predicted control (MPC) may be used for providing a solution to the large convex optimization problem. For example, the mechanism may generate the first financial plan, e.g., a solution to the convex optimization problem, starting at the retiree's current age such as 62, and run until the terminal age, e.g., 110. At each subsequent age after 62, e.g., 63, 64, . . . , the mechanism may re-generate a solution to the convex optimization problem until age 110. Thus, in each Monte Carlo trial, the mechanism generates a new plan at each age following the convex optimization-based policy described above. The trials will differ in the realization of random variables such as returns but will all follow the same policy. The plan generated at the starting age will be the same for all trials (assuming none of the initial state is random), but afterwards the plans generated at each age will diverge. Further details of the MPC can be found in Section 5. of Appendix I.

As used herein, the term “tax” refers to any involuntary fixed-rate or lockstep-rate liability charge, which includes, but not limited to income tax, capital gain tax according to the tax law under various jurisdictions. It is noted that embodiments described herein apply to “tax” aware portfolio optimization for illustrative purpose only. The systems, methods, and/or apparatus described herein relating to portfolio optimization are applicable to any portfolio optimization with an involuntary liability charge, such as but not limited to an insurance regulatory charge, a carbon/pollution charge, and/or the like.

As used herein, the term “substantially” refers to a characteristic that achieve a certain property for the most part. For example, a set of variables that maximizes a numerical approximation of an objective function may be referred to as substantially maximizes the original objective function.

As used herein, the term “module” may comprise hardware or software-based framework that performs one or more functions. In some embodiments, the module may be implemented on one or more processors, neural networks, and/or the like.

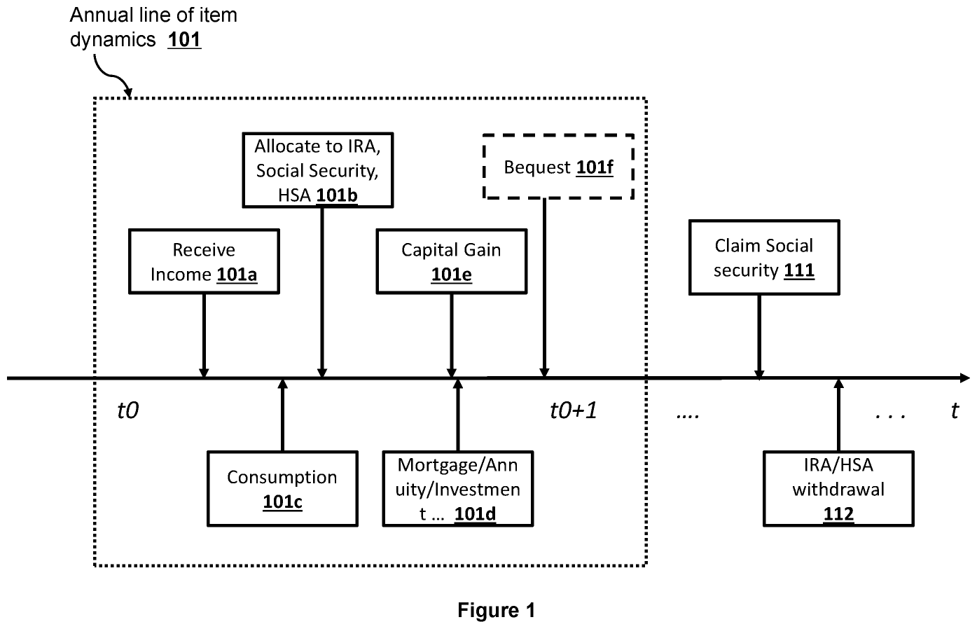

FIG. 1 is a simplified diagram illustrating an example of timeline-based decumulation strategy planning, according to some embodiments described herein. During a user's (retiree) lifetime, the user may perform a sequence of action over the years.

For a given year, the retiree may cause a number of line items. A line item represents an asset, an ongoing expense, or any other item of accounting significance. Decumulation is about the interaction of line items as the retiree ages. For example, annual line of item dynamics 101 may include receiving an income 101a, consuming an amount 101c, allocating to IRA, HSA, social security, and/or the like 101b, paying mortgage, annuity or after-tax investment 101d, making a bequest 101f if the user decumulates at this year. For another example, in later years in lifetime, the user may claim social security 111, and/or withdraw from the IRA or HSA account subject to regulatory rules 112.

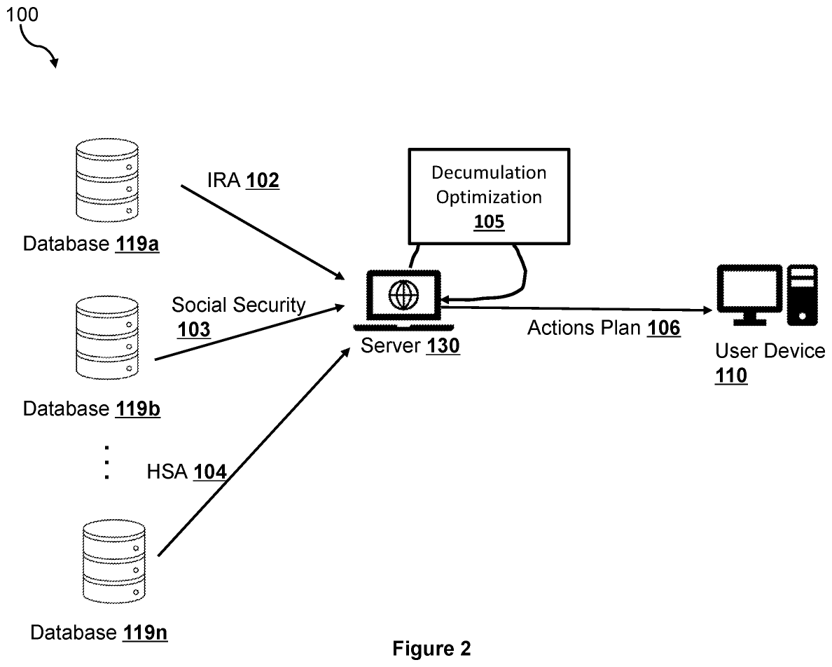

FIG. 2 is a simplified diagram illustrating a server interacting with various entities to generate the decumulation strategy described in FIG. 1, according to some embodiments described herein. Diagram 100 shows a server 130, various databases 119a-n, a user device 110, and/or the like interact with each other, e.g., via a communication network. In diagram 100, a certain number of databases, 119a-n, are shown for illustrative purposes, while more than such number of databases may be communicative with the server 130.

In one embodiment, the server 130 may receive various account information from the databases 119a-n. For example, the server 130 may receive IRA account information 102, social security information 103, HSA account information 104, and/or the like. The server 130 may generate an input of values of a retiree's brokerage, IRA, and Roth IRA accounts, their Social Security income, and one or more forecasts of market returns for the next 40 years may be input to the decumulation optimization module 105. The module 105 may in turn generate an output in the form of a complete financial plan 106 to a user device 110 over the next 40 years. The plan gives how much to withdraw (or deposit) from each account (and for the brokerage account, which lots to sell); how much to transfer among accounts (respecting the rules, of course), how much (if any) of annuity and term life insurance to purchase each year, and a target consumption amount.

Specifically, the decumulation optimization module 105 intakes account information 102-104, and translates various account information into one or more convex constraints over a consumption variable, an income variable, a taxable income variable, and a bequest variable at the current year. The decumulation optimization module further implements a convex optimization procedure to find a solution to a convex optimization problem that maximizes a utility representing the lifetime expectation of assets subject to these convex constraints. In this way, the resulting optimal consumption variable, income variable, taxable income variable, and bequest variable at the current year defines an action plan for the user, e.g., how much to consume, how much to invest in a tax-advantaged account, and how much to bequest if decumulation happens at the current year.

For example, retirement may begin at age t₀ (65 by default), and let t_{d} denote the (stochastic) age of death. Let p_{t+1|t} denote the probability that t_{d}≥t+1 given they are age t. Let Pₜ=Πᵢ₌ₜ_{₀}^{t}p_{i|i-1} denote the probability that t_{d}≥t, given they are age t₀.

Specifically, let n denote the number of line items, and T the number of ages considered (e.g., T=115−t₀+1). Variables involved in the decumulation process may include an income matrix V∈R^{n×T}, a taxable income matrix \tilde{V}∈R^{n×T}, a capital gains matrix G∈R^{n×T}, a consumption vector c∈R^{T}, a bequest value matrix B∈R^{n×T}. All the above variables have units of real (i.e., inflation adjusted to t₀) dollars.

At age t line item i generates income Vᵢₜ, taxable income \tilde{V}ᵢₜ, capital gains Gᵢₜ, and bequest value Bᵢₜ. The accumulation of line items is computed by

$${V}_{t} = {1}^{T} {V}_{1 : n , t} , {\tilde{V}}_{t} = {1}^{T} {\tilde{V}}_{1 : n , t} , {G}_{t} = {1}^{T} {G}_{1 : n , t} , {B}_{t} = {1}^{T} {B}_{1 : n , t}$$

Negative income is interpreted as expenses, negative taxable income as deductions, negative capital gains as capital losses, and negative bequest value as debt. Each line item i also has a (convex) constraint set [symbol] ᵢ, such that:

$$( {V}_{i , {t}_{0} : 115} , {\tilde{V}}_{i , {t}_{0} : 115} , {G}_{i , {t}_{0} : 115} , {B}_{i , {t}_{0} : 115} ) ∈ {𝒞}_{i}$$

The constraint set represents internal variables and dynamics. At each age t, the retiree follows the action sequence below: (1) The retiree receives income Vₜ, of which \tilde{V}ₜ is taxable. (2) Internal state of line items is updated (e.g., returns are realized on investments). (3) The retiree is taxed on taxable income \tilde{V}ₜ. (4) The retiree consumes cₜ and (5) If t=t_{d}, a bequest Bₜ is made.

Thus, to simulate the decumulation process, the decumulation problem may be configured for starting age t₀, execute (or recommend) all actions planned for the current age, and then increment t₀ by one and repeat.

At each age t the retiree consumes cₜ. The consumption utility at age t is given by

$${U}^{con} ( {c}_{t} ) = {( {c}_{t} )}^{{γ}^{con}} / {γ}^{con} ,$$

where γ^{con}<1 expresses risk-aversion. For γ^{con}=0, the consumption utility is computed as:

$${U}^{con} ( {c}_{t} ) = log ( {c}_{t} ) .$$

The consumption utility is concave and increasing.

The value of the bequest if t=t_{d} is given by Bₜ. Bequests are not subject to capital gains tax. The utility of the bequest is computed as:

$${U}^{beq} ( {B}_{t} ) = {{T}^{beq} ( {B}_{t} / {T}^{beq} )}^{{γ}^{beq}} / {γ}^{beq} ,$$

where γ^{beq}<1 expresses risk-aversion and T^{beq} is the number of years over which the beneficiary will spend the bequest. For γ^{beq}=0, the bequest utility is computed as:

$${U}^{beq} ( {B}_{t} ) = {T}^{beq} log ( {B}_{t} / {T}^{beq} ) .$$

The bequest utility is concave and increasing.

Therefore, the decumulation optimization module 105 may compute the objective of the decumulation problem combines the consumption and bequest utilities. Let I(t<t_{d}) be the indicator function taking value 1 if t<t_{d} and 0 otherwise. Let I(t=t_{d}) be similarly defined. The lifetime utility is the random variable

$$U ( C , B ) = {{\sum }^{115}}_{t = {t}_{0}} I ( t < {t}_{d} ) ( {U}^{con} ( {c}_{t} ) + I ( t = {t}_{d} ) {U}^{beq} ( {B}^{t} ) ) .$$

The optimization objective is to maximize expected lifetime utility

$${E}_{{t}_{d}} U ( c , B ) = {{\sum }^{115}}_{t = {t}_{0}} {P}_{t} ( {U}^{con} ( {c}_{t} ) + ( 1 - {p}_{t + 1 \vert t} ) {U}^{beq} ( {B}_{t} ) ) .$$

Here t_{d} is the only random variable.

In addition, the decumulation optimization module 105 may compute income tax at age t is given by the function

$${f}^{inc} ( {\tilde{V}}_{t} ) = {{\sum }^{k}}_{i = 1} ( {ρ}_{i} - {ρ}_{i - 1} ) {( {\tilde{V}}_{t} - {d}_{i} )}_{+ ,}$$

where 0=ρ₀< . . . <ρₖ and 0<d₁< . . . <dₖ. Note that f^{inc} is nonnegative, convex, and piecewise linear. For a single filer claiming the standard deduction in 2020, federal income taxes are given by the parameters k=7,

$$ρ = ( 0 , 0.1 , 0.12 , 0.22 , 0.24 , 0.32 , 0.35 , 0.37 ) ,$$

$$and$$

$$d = ( 0 , 9875 , 40124 , 85525 , 163300 , 207350 , 518400 ) + 12400.$$

These numbers are adjusted for inflation. Computationally, the calculation of income tax can be conducted as follows: First, ρ^{cum} is formed, where

$${ρ}_{i}^{cum} = {{\sum }^{i}}_{j = 1} {ρ}_{i - 1} ( {d}_{j} - {d}_{j - 1} ) ,$$

for i=1, . . . , k. The ith element represents the cumulative tax one would pay on the first dᵢ dollars of taxable income one generates. Next construct matrix τ∈R^{T×k} defined by

$$τ = [ \begin{matrix}{\tilde{V}}_{1} - {d}_{1} & … & {\tilde{V}}_{1} - {d}_{k} \\ ⋮ & & ⋮ \\ {\tilde{V}}_{T} - {d}_{1} & … & {\tilde{V}}_{T} - {d}_{k}\end{matrix} ] .$$

Next, the ith column of τ is scaled by ρᵢ to obtain

$$R ∘ τ = [ \begin{matrix}{ρ}_{1} ( {\tilde{V}}_{1} - {d}_{1} ) & … & {ρ}_{k} ( {\tilde{V}}_{1} - {d}_{k} ) \\ ⋮ & & ⋮ \\ {ρ}_{1} ( {\tilde{V}}_{T} - {d}_{1} ) & … & {ρ}_{k} ( {\tilde{V}}_{T} - {d}_{k} )\end{matrix} ] ,$$

where R=[ρ₁1 . . . ρₖ1]. The element (R∘τ)ₜⱼ indicates the tax paid on the taxable income generated above dₖ. Next, let M∈R^{T×k} be given by

$$M = [ \begin{matrix}{ρ}_{1}^{cum} 1 & … & {ρ}_{k}^{cum} 1\end{matrix} ] ,$$

and compute the sum M+R∘τ:

$$M + \text{} R ∘ \text{} τ = \\ [ \text{} \begin{matrix}{ρ}_{1} ( {\tilde{V}}_{1} - {d}_{1} ) & … & {ρ}_{k} ( {\tilde{V}}_{1} - {d}_{k} ) + {ρ}_{k - 1} ( {d}_{k} - {d}_{k - 1} ) + … + {ρ}_{1} ( {d}_{2} - {d}_{1} ) \\ ⋮ & & ⋮ \\ {ρ}_{1} ( {\tilde{V}}_{T} - {d}_{1} ) & … & {ρ}_{k} ( {\tilde{V}}_{T} - {d}_{k} ) + {ρ}_{k - 1} ( {d}_{k} - {d}_{k - 1} ) + … + {ρ}_{1} ( {d}_{2} - {d}_{1} )\end{matrix} ] .$$

Note that the maximum value in each row i occurs at the index 1≤j≤k such that dⱼ≤\tilde{V}ᵢ≤dⱼ₊₁ (with dₖ₊₁=∞). Taking the maximum of each row, a vector is obtained in R₊^{T} that represents the income tax paid each period.

The decumulation optimization module 105 may also compute capital gains tax at age t is given by the function:

$${f}^{cap} ( {\tilde{V}}_{t} , {G}_{t} ) = {{\sum }^{k}}_{i = 1} ( {ρ}_{i} - {ρ}_{i - 1} ) {( {G}_{t} - {( {d}_{i} - {\tilde{V}}_{t} )}_{+} )}_{+ ,}$$

where 0=ρ₀< . . . <ρₖ and 0<d₁< . . . <dₖ. Note that f^{cap} is nonnegative, convex, and piecewise linear in capital gains Gₜ, but nonconvex in taxable income \tilde{V}ₜ.

For instance, for a single filer in 2020, federal capital gains taxes are given by the parameters k=3,

$$ρ = ( 0 , 0 , 0.15 , 0.2 ) ,$$

$$and$$

$$d = ( 0 , 40000 , 441450 ) .$$

These numbers are adjusted for inflation.

For a single filer with taxable income \tilde{V}ₜ between $40,000 and $441,450, federal capital gains tax is jointly convex and piecewise linear with respect to capital gains and ordinary income. Specifically, the capital gain can be computed by:

$${f}^{cap} ( {\tilde{V}}_{t} , {G}_{t} ) = 0.15 {( {G}_{t} )}_{+} + 0.05 {( {G}_{t} - ( 441450 - {\tilde{V}}_{t} ) )}_{+ .}$$

A similar approach yields a jointly convex capital gains tax function for other filing statuses, so it is assumed f^{cap} is jointly convex in the sequel.

The accounting equality specifies that income equals consumption plus taxes:

$${V}_{t} = {c}_{t} + {f}^{inc} ( {\tilde{V}}_{t} ) + {f}^{cap} ( {\tilde{V}}_{t} , {G}_{t} ) , t = {t}_{0} , … , 115.$$

The equality is not convex, which may be relaxed to an inequality by allowing the retiree to consume less than the accounting suggests: The accounting equality specifies that income equals consumption plus taxes:

$${V}_{t} \geq {c}_{t} + {f}^{inc} ( {\tilde{V}}_{t} ) + {f}^{cap} ( {\tilde{V}}_{t} , {G}_{t} ) , t = {t}_{0} , … , 115.$$

The inequality will be tight at the solution because increasing consumption always increases the objective.

Therefore, the decumulation optimization module 105 may compute the decumulation problem as:

$$\begin{matrix}maximize & {{\sum }^{115}}_{t = {t}_{0}} {P}_{t} ( {U}^{con} ( {c}_{t} ) + ( 1 - {p}_{t + 1 \vert t} ) {U}^{beq} ( {B}_{t} ) ) \\ subject to & {V}_{t} \geq {c}_{t} + {f}^{inc} ( {\tilde{V}}_{t} ) + {f}^{cap} ( {\tilde{V}}_{t} , {G}_{t} ) , t = {t}_{0} , … , 115 \\ & {c}_{t} \geq 0 , t = {t}_{0} , … , 115 \\ & ( V , \tilde{V} , G , B ) ∈ {𝒞}_{1} \times … \times {𝒞}_{n} .\end{matrix}$$

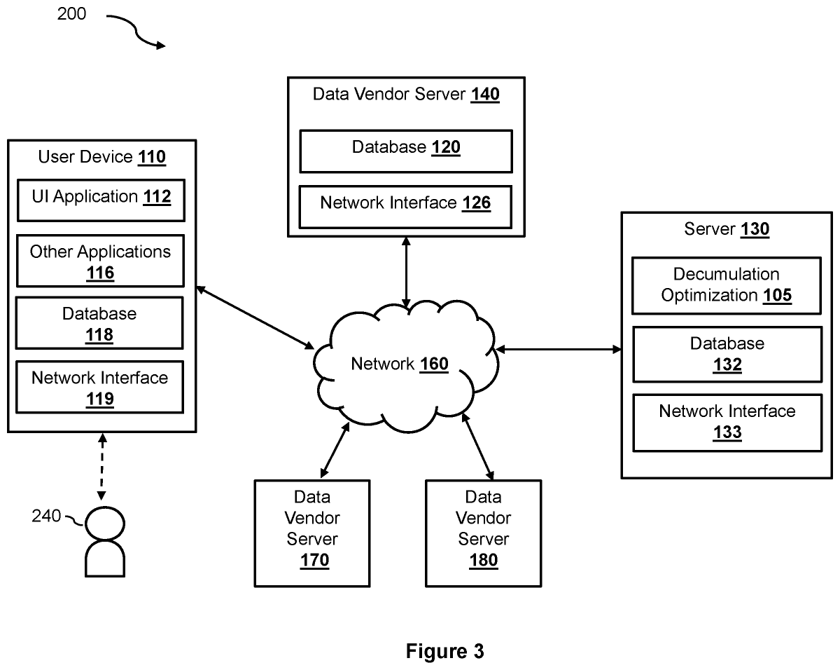

FIG. 3 is a block diagram 200 of a networked system suitable for implementing the processes described in FIG. 2 and other embodiments described herein, according to an embodiment. In one embodiment, block diagram 200 shows a system including the user device 110 which may be operated by user 240, data vendor servers 140, 170 and 180, server 130, and other forms of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 2 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

The user device 110, data vendor servers 140, 170 and 180, and the server 130 may communicate with each other over a network 160. User device 110 may be utilized by a user 240 to access the various features available for user device 110, which may include processes and/or applications associated with the server 130 to receive an action plan.

User device 110, data vendor server 140, and the server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 160.

User device 110 may be implemented as a communication device that may utilize appropriate hardware and software configured for wired and/or wireless communication with data vendor server 140 and/or the server 130. For example, in one embodiment, user device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 110 of FIG. 2 contains a user interface (UI) application 112, and/or other applications 116, which may correspond to executable processes, procedures, and/or applications with associated hardware. For example, the user device 110 may receive a data anomaly message from the server 130 and display the data anomaly message via the UI application 112. In other embodiments, user device 110 may include additional or different modules having specialized hardware and/or software as required.

In various embodiments, user device 110 includes other applications 116 as may be desired in particular embodiments to provide features to user device 110. For example, other applications 116 may include security applications for implementing client-side security features, programmatic client applications for interfacing with appropriate application programming interfaces (APIs) over network 160, or other types of applications. Other applications 116 may also include communication applications, such as email, texting, voice, social networking, and IM applications that allow a user to send and receive emails, calls, texts, and other notifications through network 160. For example, the other application 116 may be an email or instant messaging application that receives a data anomaly message from the server 130. Other applications 116 may include device interfaces and other display modules that may receive input and/or output information. For example, other applications 116 may contain software programs, executable by a processor, including a graphical user interface (GUI) configured to provide an interface to the user.

User device 110 may further include database 118 stored in a transitory and/or non-transitory memory of user device 110, which may store various applications and data and be utilized during execution of various modules of user device 110. Database 118 may store received data anomaly messages, user review data relating to the data anomaly message, and/or the like. In some embodiments, database 118 may be local to user device 110. However, in other embodiments, database 118 may be external to user device 110 and accessible by user device 110, including cloud storage systems and/or databases that are accessible over network 160.

User device 110 includes at least one network interface component 119 adapted to communicate with data vendor server 140 and/or the server 130. In various embodiments, network interface component 119 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 140 (similar to one of the databases 119a-n in FIG. 1) may correspond to a server that hosts the database 120 to provide data records to the server 130. For example, the database 120 may be a financial information database storing information relating to various financial instruments. A bond record in the database 120, for instance, may include data attributes such as the country of origin, issuer, issue date, tenor, currency, expiration date, and/or the like. The database 120 may be implemented by one or more relational database, distributed databases, cloud databases, and/or the like.

The data vendor server 140 includes at least one network interface component 126 adapted to communicate with user device 110 and/or the server 130. In various embodiments, network interface component 126 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 140 may send data records retrieved from the database 120, via the network interface 126, to the server 130.

The server 130 may be housed with a decumulation optimization module 105. In some implementations, the decumulation module 105 may be a neural network model that is based on hardware, software or a combination thereof.

The database 132 may be stored in a transitory and/or non-transitory memory of the server 130. In various embodiments, for example, the database 120 may be a financial information database storing information relating to various financial instruments. In one implementation, the database 132 may store data records obtained from the data vendor server 140. In some embodiments, database 132 may be local to the server 130. However, in other embodiments, database 132 may be external to the server 130 and accessible by the server 130, including cloud storage systems and/or databases that are accessible over network 160.

The server 130 includes at least one network interface component 133 adapted to communicate with user device 110 and/or data vendor servers 140, 170 or 180 over network 160. In various embodiments, network interface component 133 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 200.

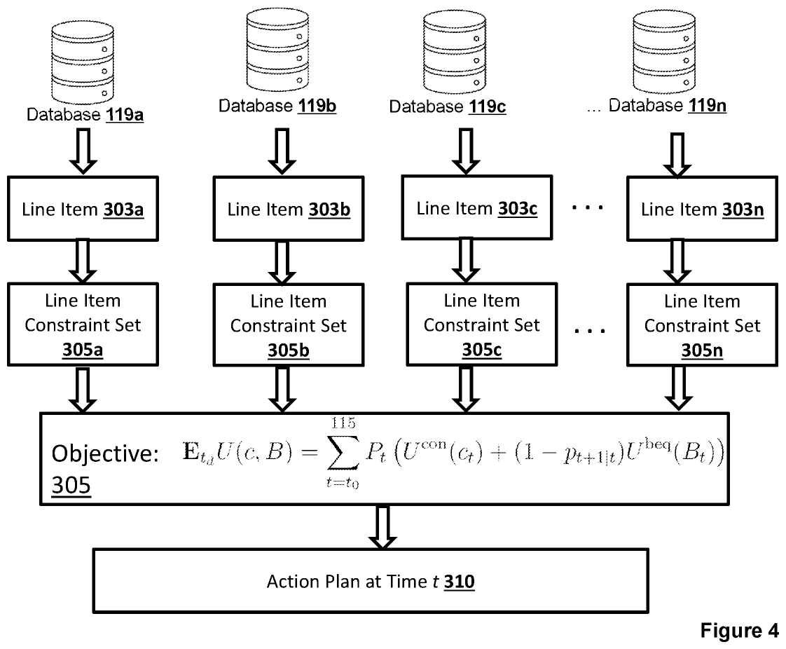

FIG. 4 is a simplified diagram illustrating formulating a lifetime optimization problem with convex line item constraints representing various account dynamics, according to some embodiments described herein. For example, line items 303a-n may be computed based on account information from databases 119a-n, respectively. Each line item 303a-n may then be formulated as a convex line item constraint set 305a-n over the optimization objective 305, as described in relation to FIG. 1. In this way, a convex optimization procedure can be applied to solve the problem resulting in an action plan at time t 310.

For example, one of the line items 303a-n may include investment accounts of a retiree. Assuming a retiree has three accounts: brokerage, IRA, and Roth IRA. The brokerage account is funded with after-tax dollars and capital gains in the account are taxed. The IRA account is funded with pre-tax dollars and capital gains in the account are not taxed. The Roth IRA account is funded with after-tax dollars and capital gains in the account are not taxed. Let xₜ∈R₊³ denote the vector (brokerage value, IRA value, Roth IRA value) at year t in real dollars (inflation-adjusted to today).

At each age t, fund is withdrawn from and added to the accounts xₜ. Let wₜ∈R³ denote the account withdrawals/additions (i.e., the updated accounts are given by xₜ−wₜ). (wₜ)ᵢ<0 means fund being added to the account. Net withdrawals are given by 1^{T}wₜ.

At age 70 (or 72, depending on when the retiree was born), there is a minimum required distribution (RMD) from the IRA, (xₜ)₂/mₜ, where mₜ is roughly the retiree's expected lifespan given they are alive at age t. No money can be added to the IRA. However, money can be converted from the IRA to the Roth IRA, in excess of the RMD. In short, the constraints can be computed as:

$$\begin{matrix}{( {w}_{t} )}_{2} \geq 0 , & t = 65 , … , 69 , \\ {( {w}_{t} )}_{2} \geq {( {x}_{t} )}_{2} / {m}_{t} , & t = 70 , … , 115 , \\ {( {( {w}_{t} )}_{3} )}_{-} \leq {( {w}_{t} )}_{2} , & t = 65 , … , 69 , \\ {( {( {w}_{t} )}_{3} )}_{-} \leq {( {w}_{t} )}_{2} - {( {x}_{t} )}_{2} / {m}_{t} , & t = 70 , … , 115.\end{matrix}$$

Assuming that the yearly returns of the portfolio in the three accounts are constant and known, given by the vector r∈R³. Returns are inflation adjusted. The dynamics of the account values is given by

$${x}_{t + 1} = ( 1 + r ) ∘ ( {x}_{t} - {w}_{t} ) , t = {t}_{0} , … , 115.$$

$$( {x}_{{t}_{0}} , … , {x}_{115} \geq 0. )$$

Thus, the line item constraints [symbol] ᵢ include all the above constraints as well as

$$\begin{matrix}{V}_{i , t} = {1}^{T} {w}_{t} , & t = {t}_{0} , … , 115 , \\ {V}_{i , t} = {( {w}_{t} )}_{2} , & t = {t}_{0} , … , 115 , \\ {G}_{i , t} = {{r}_{1} ( {x}_{t} - {w}_{t} )}_{1} , & t = {t}_{0} , … , 115 , \\ {B}_{i , t} = {( 1 , 0.8 , 1 )}^{T} {x}_{t + 1} , & t = {t}_{0} , … , 115.\end{matrix}$$

The capital gains model G_{i,t}=r₁(xₜ−wₜ)₁ assumes that the retiree cashes out and reinvests the brokerage account at the end of each year. More realistic models of capital gains may be developed. The bequest value B_{i,t}=(1,0.8,1)^{T}xₜ is a crude approximation that accounts for the fact that income tax must be paid by the beneficiary on withdrawals from the IRA.

Therefore, the line item constraint corresponding to an involuntary liability (e.g., tax) advantaged account includes at least a first constraint that a minimum required distribution of the account value divided by an expected lifespan from the current time is withdrawn when the user is older than a pre-defined age limit at a future time, and a second constraint that no additional amount is added to the liability advantaged account when the user is older than the pre-defined age limit at the future time.

For another example, one of the line items 303a-n may include the social security of a retiree. Assuming that retiree has claimed Social Security, receiving Social Security income s each year (in real dollars). The line item constraints [symbol] ᵢ are given by

$$\begin{matrix}{V}_{i , t} & = s , & t = {t}_{0} , … , 115 , \\ \tilde{{V}_{i , t}} & = 0.85 s , & t = {t}_{0} , … , 115 , \\ {G}_{i , t} & = 0 , & t = {t}_{0} , … , 115 , \\ {B}_{i , t} & = 0 , & t = {t}_{0} , … , 115.\end{matrix}$$

Assuming here adjusted gross income plus s/2 is greater than $34,000. (When this is not the case, different fractions of social security are taxed.) Therefore, the line item constraint relating to a deferred compensation account such as social security takes a form that the taxable income variable equals the income variable times a pre-defined annual income deferral ratio.

For another example, one of the line item constraints 305a-n may include a variation of social security claiming year. Social Security may be claimed at any age between 62 and 70. Social Security payments begin the year the benefit is claimed. The size of the retiree's annual Social Security income is a function of the retiree's primary insurance amount (PIA) and the claiming age. The PIA is a function of the retiree's labor income history. The claiming age determines the factor by which the PIA will be multiplied to determine the annual Social Security income. The multiple increases monotonically from 0.7 for age 62 to 1.24 for age 70. Choosing a claiming age is not convex, so the problem is relaxed to allow a convex combination of claiming ages. Each claiming age represents a cash flow beginning at that age, and a convex combination of those cash flows is chosen. Let s₆₂, . . . , s₇₀∈R₊^{115-t}^{₀} denote the cash flows. Let θ₆₂, . . . , θ₇₀∈R₊ denote the coefficients of the convex combination, satisfying the constraint Σᵢ₌₆₂⁷⁰θᵢ=1,

The line item constraints [symbol] ᵢ include all the above constraints as well as

$$\begin{matrix}{V}_{i , t} & = {{\sum }^{70}}_{i = 62} {( {θ}_{i} {s}_{i} )}_{t} , & t = {t}_{0} , … , 115 , \\ {\tilde{V}}_{i , t} & = 0.85 {{\sum }^{70}}_{i = 62} {( {θ}_{i} {s}_{i} )}_{t} , & t = {t}_{0} , … , 115 , \\ {G}_{i , t} & = 0 , & t = {t}_{0} , … , 115 , \\ {B}_{i , t} & = 0 , & t = {t}_{0} , … , 115.\end{matrix}$$

Here s₆₂, . . . , s₇₀ are constants and θ₆₂, . . . , θ₇₀ are optimization variables. After solving the convex problem, the claiming age is chosen to be the largest θᵢ. The problem can be solved again with the additional constraints that θᵢ=1 if i is the claiming age and θᵢ=0 otherwise. It is noted that the choice of claiming age is revokable until the claiming age equals t₀. For example, at age 66 the optimizer might choose the claiming age 68, but that decision can be altered when the optimizer is run again at age 67. However, if the optimizer chose the claiming age 66 the decision would be irrevocable.

For another example, one of the line items 303a-n may include annuities of a retiree. For instance, single premium immediate annuities (SPIAs) may be purchased at age t₀. The possibility of buying annuities at later ages may not be included, but each time t₀ is incremented again, annuity purchases are allowed. SPIAs pay a fixed nominal amount every age after the purchase age. Let p be the price per dollar of annuity payment and q the amount of annuity payment purchased. The line item constraints [symbol] ᵢ are given by computing the income variable at the current time based on an amount of annuity payment purchased and an inflation rate, and computing the taxable income variable based on an exclusion ratio of the annuity purchased and the computed income variable:

$$\begin{matrix}{V}_{i , {t}_{0}} = - pq , & \\ {V}_{i , t} = q / {( 1 + {r}^{inf} )}^{t - {t}_{0}} , & t = {t}_{0} + 1 , … , 115 , \\ {\tilde{V}}_{i , {t}_{0}} = 0 , & \\ {\tilde{V}}_{i , t} = ( 1 - {f}_{t} ) q / {( 1 + {r}^{inf} )}^{t - {t}_{0}} , & t = {t}_{0} + 1 , … , 115 , \\ {G}_{i , t} = 0 , & t = {t}_{0} , … , 115 , \\ {B}_{i , t} = 0 , & t = {t}_{0} , … , 115 ,\end{matrix}$$

where r^{inf} is the (constant, known) inflation rate and the exclusion ratio fₜ∈[0,1] depends on age t and various attributes of the annuity. (assuming the annuity is purchased with after-tax dollars.) There are many other kinds of annuities, such as deferred income annuities and annuities with bequest value.

For another example, one of the line items 303a-n may include real estate of a retiree. Assuming that at age t₀, the retiree owns vₜ_{₀}∈R₊ dollars of real estate. This is assumed to grow at a constant rate with respect to inflation, i.e.,

$${v}_{t + 1} = ( 1 + {r}_{e} ) {v}_{t} .$$

If rₑ=0, their home equity grows at the rate of inflation. (Reasonable numbers here are rₑ∈[0,0.02].) If they rent portions of their real estate, this generates taxable income rₜ, which is assumed to grow at the rate of inflation (so stay constant in real dollars). This generates the line items

$$\begin{matrix}{V}_{i , t} = {r}_{t} , & t = {t}_{0} , … , 115 , \\ {\tilde{V}}_{i , t} = {r}_{t} , & t = {t}_{0} , … , 115 , \\ {G}_{i , t} = 0 , & t = {t}_{0} , … , 115 , \\ {B}_{i , t} = {v}_{t + 1} , & t = {t}_{0} , … , 115.\end{matrix}$$

For another example, one of the line items 303a-n may include the mortgage of a retiree. The retiree can also have one or more mortgages (here we consider the case of one mortgage). Suppose the retiree has a fixed-rate mortgage with a principal balance bₜ, a yearly interest rate i, and a fixed payment c. Suppose also that they plan to pay off the mortgage in the next M years. Each year they pay pₜ dollars on the mortgage. Of the pₜ dollars they pay, ibₜ dollars go to interest, and pₜ−ibₜ goes to paying off the principal balance. Therefore, the dynamics are

$${b}_{t + 1} = ( {b}_{t} - {p}_{t} + {ib}_{t} ) / ( 1 + {r}^{inf} ) , t = {t}_{0} , … , T - 1$$

In addition, there are the minimum payment constraints,

$${p}_{t} \geq c / {( 1 + {r}^{inf} )}^{t - {t}_{0}} , t = {t}_{0} , … , {t}_{0} + M - 2 ,$$

(This is not enforced at t₀+M−1 because the final payment might be less than the minimum payment.) and the constraint that the mortgage is fully paid off starting at year M,

$${b}_{t} = 0 , t \geq M .$$

A mortgage generates the line item constraints

$$\begin{matrix}{V}_{i , t} = - {p}_{t} , & t = {t}_{0} , … , 115 , \\ {\tilde{V}}_{i , t} = 0 , & t = {t}_{0} , … , 115 , \\ {G}_{i , t} = 0 , & t = {t}_{0} , … , 115 , \\ {B}_{i , t} = - {b}_{t + 1} , & t = {t}_{0} , … , 115.\end{matrix}$$

For another example, one of the line items 303a-n may include life insurance of a retiree. A simplified model of life insurance is that the retiree pays a fixed nominal amount p per year for M years, and the beneficiary receives a payout b if the retiree dies before the end of the M years. Such a policy is called term life insurance. The line item constraints [symbol] ᵢ are given by

$$\begin{matrix}{V}_{i , t} = - p / {( 1 + {r}^{inf} )}^{( t - {t}_{0} )} , & t = {t}_{0} , … , {t}_{0} + M - 1 , \\ {V}_{i , t} = 0 , & t = {t}_{0} + M , … , 115 , \\ {\tilde{V}}_{i , t} = 0 , & t = {t}_{0} , … , 115 , \\ {G}_{i , t} = 0 , & t = {t}_{0} , … , 115 , \\ {B}_{i , t} = b / {( 1 + {r}^{inf} )}^{( t - {t}_{0} )} , & t = {t}_{0} , … , {t}_{0} + M - 1 , \\ {B}_{i , t} = 0 , & t = {t}_{0} + M , … , 115.\end{matrix}$$

Here r^{inf} is the inflation rate.

For another example, one of the line items 303a-n may include dividends paid to a retiree. A simplified model of dividends is that dividends pay out in fixed proportion to the brokerage holdings (xₜ)₁. Let r^{div} be the dividend fraction. The line item constraints [symbol] i are given by

$$\begin{matrix}{V}_{i , t} = {{r}^{div} ( {x}_{t} )}_{1} , & t = {t}_{0} , … , 115 , \\ {\tilde{V}}_{i , t} = {{r}^{div} ( {x}_{t} )}_{1} , & t = {t}_{0} , … , 115 , \\ {G}_{i , t} = 0 , & t = {t}_{0} , … , 115 , \\ {B}_{i , t} = 0 , & t = {t}_{0} , … , 115.\end{matrix}$$

The brokerage account return r₁ is adjusted by subtracting r^{div}. (Dividends can be incorporated directly into IRA/Roth IRA returns, since they have no income tax consequences.)

For another example, one of the line items 303a-n may include deferred capital losses of a retiree. A simplified model of deferred capital losses is that we enter age t₀ with Lₜ_{₀}∈R₊ in accumulated capital losses. At each age t, we apply aₜ^{inc}∈[0,3000] of the accumulated capital losses as a deduction from taxable income. aₜ^{cap}∈R₊ of accumulated losses is applied to capital gains. The dynamics are given by

$${L}_{t + 1} = {L}_{t} / ( 1 + {r}^{inf} ) - {a}_{t}^{i n c} - {a}_{t}^{c a p} , t = {t}_{0} , … , 114 ,$$

where r^{inf} is the inflation rate. We assume that capital losses other than those applied from the initial store of losses are not deferred (i.e., deducted from capital gains for that same year). The line item constraints [symbol] ᵢ are given by

$$\begin{matrix}{V}_{i , t} = 0 , & t = {t}_{0} , … , 115 , \\ {\tilde{V}}_{i , t} = - {a}_{t}^{inc} , & t = {t}_{0} , … , 115 , \\ {G}_{i , t} = - {a}_{t}^{cap} , & t = {t}_{0} , … , 115 , \\ {B}_{i , t} = 0 , & t = {t}_{0} , … , 115.\end{matrix}$$

For another example, one of the line items 303a-n may include deferred pensions of a retiree. A simplified model of a pension is that the retiree receives a fixed nominal payment p for life. The income is taxable. The line item constraints [symbol] ᵢ are given by

$$\begin{matrix}{V}_{i , t} = p / {( 1 + {r}^{inf} )}^{( t - {t}_{0} )} , & t = {t}_{0} , … , 115 , \\ {\tilde{V}}_{i , t} = p / {( 1 + {r}^{inf} )}^{( t - {t}_{0} )} , & t = {t}_{0} , … , 115 , \\ {G}_{i , t} = 0 , & t = {t}_{0} , … , 115 , \\ {B}_{i , t} = 0 , & t = {t}_{0} , … , 115.\end{matrix}$$

Here r^{inf} is the inflation rate. More complex pensions might allow the choice of taking payment as a lump sum up front.

For another example, one of the line items 303a-n may include personal loans of a retiree. A simplified model of a personal loan is that the retiree receives an initial sum L and pays a fixed nominal amount p for M subsequent years. The loan is not taxable income. Assuming the retiree's estate pays the remaining loan payments. The line item constraints [symbol] ᵢ are given by

$$\begin{matrix}{V}_{i , {t}_{0}} = L , & \\ {V}_{i , t} = - p / {( 1 + {r}^{inf} )}^{( t - {t}_{0} )} , & t = {t}_{0} + 1 , … , {t}_{0} + M , \\ {V}_{i , t} = 0 , & t = {t}_{0} + M + 1 , … , 115 , \\ {\tilde{V}}_{i , t} = 0 , & t = {t}_{0} , … , 115 , \\ {G}_{i , t} = 0 , & t = {t}_{0} , … , 115 , \\ {B}_{i , t} = ( - Mp + ( t - {t}_{0} ) p ) / {( 1 + {r}^{inf} )}^{( t - {t}_{0} )} , & t = {t}_{0} , … , {t}_{0} + M , \\ {B}_{i , t} = 0 , & t = {t}_{0} + M + 1 , … , 115.\end{matrix}$$

Here r^{inf} is the inflation rate.

For another example, one of the line items 303a-n may include windfalls of a retiree. Anticipated windfalls, such as from selling a business, in our model. To plan against a cash payment C at time t, the line item constraints [symbol] ᵢ are given by

$$\begin{matrix}{V}_{i , t} = I ( t = τ ) C , & t = {t}_{0} , … , 115 , \\ {V}_{i , t} = I ( t = τ ) C , & t = {t}_{0} , … , 115 , \\ {G}_{i , t} = 0 , & t = {t}_{0} , … , 115 , \\ {B}_{i , t} = 0 , & t = {t}_{0} , … , 115.\end{matrix}$$

Here assuming that all of C is taxable. In some implementations, only a fraction taxable, or C might correspond to a capital gain instead.

For another example, one of the line items 303a-n may include itemized deductions of a retiree. The retiree has the option using the standard deduction or itemizing deductions. If they itemize deductions, then they can accumulate deductions from a number of sources (possibly limited by their income) and use that amount in place of the standard deduction. Therefore, it is only worth itemizing deductions if the sum of their itemized deductions is larger than the standard deduction (which is $12400 in 2020). Assuming that a retiree either takes the standard deduction, every year or itemizes their deductions every year (more common for high-net-worth individuals). When they are itemizing deductions, this updates the tax knots d (as of 2020) to

$$d = ( 0 , 9875 , 40124 , 85525 , 163300 , 207350 , 518400 ) + {d}^{deduction} ,$$

where the deduction d^{deduction} is the amount of itemized deduction. If mₜ is spent on medical and dental expenses, then min(mₜ, 0.075Vₜ) is the deduction since the amount that can be deducted is limited to 7.5% of the income. If is iₜ^{s} spent on state and local taxes, then min(iₜ^{s}, 10000) is the deduction since the retiree is limited to $10000 in deductions from state taxes. If pₜ is spent on mortgage interest, then min(pₜ, 750000i), where i is the mortgage interest rate, is the deduction since one is only allowed to itemize interest on at most $750,000 of mortgage principal balance. If cₜ is spent on charitable contributions with appreciated stock, then min(cₜ, 0.3Vₜ) is the deduction, since one is only allowed to deduct at most 30% of your income using property with capital gain. (Business deductions are ignored here, as well as casualty/disaster/theft losses, since the for the first the retiree is by definition not working, and the second is unpredictable.) Then if Vₜ is the retiree's income, the itemized deductions in total are

$${d}^{deduction} = min ( {m}_{t} , 0.075 {V}_{t} ) + min ( {i}_{t}^{s} , 10000 ) + min ( {p}_{t} , 750000 i ) + min ( {c}_{t} , 0.3 {V}_{t} ) .$$

This is nonconvex, but can be relaxed to

$${d}^{deduction} \leq min ( {m}_{t} , 0.075 {V}_{t} ) + min ( {i}_{t}^{s} , 10000 ) + min ( {p}_{t} , 750000 i ) + min ( {c}_{t} , 0.3 {V}_{t} ) ,$$

as one can always deduct less than allowed. States also allow for itemized deductions, but all have different limits and sources of itemized deductions.

For another example, one of the line items 303a-n may include charitable giving of a retiree. If one wishes to donate to charity, a tax efficient approach is to donate assets with a large difference between their tax basis and their market value. The donor deducts the market value of the donation from taxable income, without paying any capital gains tax on the appreciation. (There are restrictions on the size of the deduction relative to your taxable income, and one cannot deduct charitable giving and also take the standard deduction.) From a line item perspective, one can view charitable giving as exchanging bequest value for a reduction in taxable income.

For another example, one of the line items 303a-n may include qualified charitable distributions of a retiree. The qualified charitable distribution (QCD) mechanism allows a retiree to donate up to $100,000 to charity from an IRA. The QCD is not subject to income tax and is subtracted from the RMD for that year. The retiree must be at lest 70½ to make a QCD.

For another example, one of the line items 303a-n may include health savings account (HSA) of a retiree. An HSA is a type of tax-advantaged account. An HSA is funded with pre-tax dollars and capital gains in the account are not taxed. Moreover, withdrawals that are spent on qualified medical expenses are not taxed. After age 65, withdrawals from the HSA may be used without penalty for non-medical expenses, but withdrawal is treated as taxable income. The retiree can only contribute to an HSA if she has a high deductible health plan (HDHP). Enrollment in any part of Medicare makes the retiree ineligible to contribute. Even if the retiree cannot contribute to an HSA, she may withdraw money from the account. The contribution limit in 2020 is $4,550 per year for an individual. If an HSA is inherited by a non-spouse, it must be cashed out and converted into taxable income that year. Under certain conditions, the retiree may once in her life rollover IRA funds (either traditional or Roth) into an HSA, up to the contribution limit.

Let xₜ∈R₊ denote the value of the account at age t in real dollars (inflation adjusted to today). Let wₜ∈R be the amount withdrawn from the account at age t. Assuming the following: the retiree does not have a HDHP and therefore may not contribute to the HSA (i.e., wₜ≥0); the return on the account portfolio is constant and known, given by r∈R; and the retiree has known qualified medical expenses qₜ∈R₊ for all ages. The dynamics of the account value is given by

$${x}_{t + 1} = ( 1 + r ) ( {x}_{t} - {w}_{t} ) , t = {t}_{0} , … , 115.$$

The line item constraints [symbol] ᵢ include all the constraints above as well as

$$\begin{matrix}{V}_{i , t} = {w}_{t} , & t = {t}_{0} , … , 115 , \\ {\tilde{V}}_{i , t} = {( {w}_{t} - {q}_{t} )}_{+} , & t = {t}_{0} , … , 115 , \\ {G}_{i , t} = 0 , & t = {t}_{0} , … , 115 , \\ {B}_{i , t} = 0.6 {x}_{t + 1} , & t = {t}_{0} , … , 115.\end{matrix}$$

Thus, the line item constraint for an HSA account is computed by computing the taxable income variable as a difference between the income variable and a known qualified medical expense at the current time; and computing the bequest variable as a fixed portion of an account value of the health savings account. The bequest value is an approximation of the tax that will be paid by the beneficiary.

For another example, one of the line items 303a-n may include trust of a retiree. Consider a simple trust, in which the retiree gifts assets to the trust to be given as part of the bequest. Let Tₜ be the trust value at age t. Each year the retiree gifts gₜ≥0. Gifts in excess of $15,000 deplete the lifetime gift/estate tax exemption. Let eₜ be the lifetime exemption remaining at age t. In 2020, the lifetime exemption for an individual is $11.58 million (double that for a couple). Gifts that exceed the exemption are taxed at 40%. The dynamics can be described by computing a line item constraint relating to the trust account that defines a relationship between the income variable and a gift amount in excess of a pre-defined gift amount limit deplete the lifetime gift exemption at the current time:

$$\begin{matrix}{g}_{t} \geq 0 , & t = {t}_{0} , … , 115 , \\ {e}_{{t}_{0}} = 11 , 580 , 000 & \\ {e}_{t + 1} \leq {e}_{t} - {( {g}_{t} - 15 , 000 )}_{+} , & t = {t}_{0} , … , 115 , \\ {T}_{t + 1} = ( {T}_{t} + {g}_{t} ) ( 1 + {r}_{t} ) , & t = {t}_{0} , … , 115.\end{matrix}$$

Here rₜ is the return on the trust holdings at age t. The line item constraints [symbol] ᵢ include all the constraints above as well as

$$\begin{matrix}{V}_{i , t} \leq - {g}_{t} - 0.4 {( {g}_{t} - {e}_{t} - 15 , 000 )}_{+} , & t = {t}_{0} , … , 115 , \\ {V}_{i , t} = 0 , & t = {t}_{0} , … , 115 , \\ {G}_{i , t} = 0 , & t = {t}_{0} , … , 115 , \\ {B}_{i , t} = {T}_{t + 1} , & t = {t}_{0} , … , 115.\end{matrix}$$

A full accounting of bequest value would consider the capital gains due when cashing out the trust holdings. Unlike inheritances, the basis of gifts is not stepped up.

For another example, one of the line items 303a-n may include spousal benefits. The spousal benefit constraint may include a spousal benefit as a second convex combination of cash flows of claiming benefit at different claiming times.

For another example, one of the line items 303a-n may include a taxable investment account of a retiree. Defining the times series of cash flows into the account u∈R^{T}, taxable income generated y∈R^{T}, capital gains g∈R^{T}, and nominal account values v∈R^{T} (which are the bequest values of the account in each time period). To specify a model for a taxable account, the set of attainable values of these vectors are specified, Or more formally, a set [symbol] such that

$$( u , y , g , v ) ∈ 𝒜$$

describes the allowable time series for the account.) Assuming that the account has only one asset, which has a deterministic annual return of r∈R₊. Thus, a model describing individual tax lots describes the account's investments at a tax lot level. To do this, first define a matrix U∈R₊^{T×T} such that Uᵢⱼ is total amount that is purchased in year i and sold in year j. h∈R₊^{T} is defined such that hᵢ is the total amount that is purchased in year i and held forever. Lots cannot be sold before they are purchased, which means that Uᵢⱼ=0 for j<i.

The time series of gross purchase amounts is given by b=U1+h∈R^{T}. The time series of gross sell amounts is given by s=(R∘U)^{T}1∈R^{T}, where R∈R^{T×T} is a constant matrix, such that Rᵢⱼ is the return on a lot purchased in year i and sold in year j, i.e.,

$${R}_{i j} = {( r + 1 )}^{j - i} ,$$

where r is the return on the account. The net cash flow into the account is u=b−s. The time series of capital gains generated by the account is g=(G∘U)^{T}1∈R^{T}, where

$${G}_{ij} = {R}_{lj} - 1 .$$

The nominal account value, as a function of time, is given by v∈R^{T}. Here vₜ is the value of the account after buying and selling for time period t, which is

$${v}_{t} = {\sum }_{i = 1}^{t} {( r + 1 )}^{t + 1 - i} ( {h}_{i} + {\sum }_{j = t + 1}^{T} {U}_{i j} ) .$$

The bequest value is equal to the account value. The time series of income generated by the account is proportional to the account value, i.e., y=d∘v, where d∈R^{T} is the time series of dividend (i.e., income) yield.

The tax lots formulation does not have an explicit state variable. The state is implicit in U and h. In order to run MPC, the problem may be solved with additional constraints (and realized returns in place of estimated returns). Let \tilde{t}>t₀ be the current age. Let Ũ∈R₊^{\tilde{t}-1×T} be the actual amounts sold or bought and intended to be sold later. Let \tilde{h}∈R₊^{t̅−1} be the amounts bought and intended to be held forever. The constraints can be computed based on a purchase amount, an amount sold and a fixed return on a purchase lot or a sell lot at the current time:

$$\begin{matrix}{U}_{ij} , \tilde{{U}_{ij} ,} & j < \tilde{t} \\ {( U 1 )}_{i} = {( \tilde{U} 1 )}_{i} + {h}_{\dot{l}} , & i < \tilde{t} .\end{matrix}$$

In another implementation, instead of using an individual-tax-lot model to describe the taxable investment account, a fungible basis model may be adopted. For example, at any one time, the investor may hold multiple tax lots each with a market value and cost basis. When selling from a tax lot, capital gains are realized on the amount sold in excess of the basis that is applied toward the sale. This applied basis is computed in proportion to the amount sold. For example, if a tax lot is worth $100, and has a cost basis of $80, then if $50 are sold, the amount of applied basis is $40, and the realized capital gain is $10. The remaining value is $50, and the remaining basis is $40.

In the fungible basis method, this proportionality restriction is relaxed, and allow the investor to choose how much basis to apply to each sale. The investor is also allowed to transfer basis between lots, i.e., to apply the basis from one lot to a sale from another lot. This has the advantage that only two numbers need to be tracked: The total value of all lots, and the total (summed) basis across all lots. Let bₜ∈R₊ denote the store of value. Let \tilde{b}ₜ∈R⁺ denote the gains deducted from the store of value. The dynamics are given by

$${b}_{t + 1} = {b}_{t} / ( 1 + {r}^{inf} ) - {( {w}_{t} )}_{1} + {\tilde{b}}_{t} ,$$

where r^{inf} is the inflation rate and (wₜ)₁ is the withdrawal from the brokerage account. When −(wₜ)₁+\tilde{b}ₜ≤0, \tilde{b}ₜ can be interpreted as realizing capital gains. When −(wₜ)₁+\tilde{b}ₜ>0 we interpret \tilde{b}ₜ as realizing capital gains as well as raising the basis of assets held by selling them and repurchasing them immediately (at a price above their basis). With fungible basis, the line item constraint [symbol] ᵢ for the investment accounts to have

$${G}_{i , t} = {\tilde{b}}_{t} , t = {t}_{0} , … , 115 ,$$

and include the basis dynamics and the constraints bₜ≥0 and \tilde{b}ₜ≥0.

In one implementation, capital gains may be tracked into the lifetime utility objective 305 by tracking the tax lots. The difficulty is that instead of simply tracking how much value is held in the brokerage account each year and how much is withdrawn, the value and withdrawals are distributed across the holdings acquired in all previous years.

Let \tilde{T}>T be the number of years that the brokerage count existed (including years before the starting age to). Let Q∈R₊^{\tilde{T}×\tilde{T}} denote the size of all tax lots. In other words, Qu is the number of shares of the single brokerage asset purchased at age i and still held at age j. In addition to the constraint Q≥0, we have Qᵢⱼ=0 for i>j (due to causality) and Q_{i,j}<Q_{i,j-1} for i<j (because tax lots can only shrink once acquired).

Let p∈R₊^{\tilde{T}} be the price of the brokerage asset at each age in nominal (as of today) dollars. If the returns are known, then p is also known. Let Dₜ=1/(1+r^{inf})^{t-t}^{₀}, where r^{inf} is the (known, constant) inflation rate. The line item constraint [symbol] ᵢ for the investment accounts with tax lots consists of the withdrawal rules for the IRA and Roth IRA, the dynamics

$${( {x}_{t + 1} )}_{2 : 3} = ( 1 + {r}_{2 : 3} ) ∘ ( {( {x}_{t + 1} )}_{2 : 3} - {( {w}_{t + 1} )}_{2 : 3} ) ,$$

the constraints on Q, and the constraints

$${V}_{i , t} = {1}^{T} {( {w}_{t + 1} )}_{2 : 3} + {D}_{t} {p}_{t} {1}^{T} ( {Q}_{1 : TT , t - 1} - {Q}_{1 : \overline{T} , t} ) \qquad t = {t}_{0} , … , 115 ,$$

$${\tilde{V}}_{i , t} = {( {w}_{t} )}_{2} , \qquad t = {t}_{0} , … , 115 ,$$

$${G}_{i , t} = {{D}_{t} ( {p}_{t} 1 - p )}^{T} ( {Q}_{1 : T , t - 1} - {Q}_{1 : T , t} ) , \qquad t = {t}_{0} , … , 115 ,$$

$${B}_{i , t} = {( 0.8 , 1 )}^{T} {( {x}_{t} )}_{2 : 3} + {D}_{t} {p}_{t} {1}^{T} {Q}_{1 : T , t} , \qquad t = {t}_{0} , … , 115.$$

A standard capital gains accounting method is average cost basis. Assuming n tax lots, with cost bases b∈R₊ⁿ and quantities q∈R₊ⁿ. If the current price of the asset is p∈R₊ and a quantity u∈R₊ⁿ is sold of each lot, where u≤q, our capital gain (or loss) is equal to

$${u}^{T} ( p - b ) .$$

The average cost basis approach prescribes a simple tax lot selection method. Suppose one wishes to sell a quantity Q of the asset. Each lot is sold proportional to its quantity:

$$u = Qq / {1}^{T} q ,$$

resulting in a capital gain (or loss) of

$$Q ( p - {b}^{avg} ) ,$$

where b^{avg} is the average basis,

$${b}^{avg} = {q}^{T} b / {1}^{T} q .$$

The advantage about using the average cost basis approach is that we only need to keep track of one tax lot, which has the average cost basis of all our shares. And it is immediately implementable. That is, the system only needs to keep track of the total number of shares, qₜ∈R₊, and the average cost basis bₜ∈R₊. If Q shares are sold at a price p, the dynamics are

$${q}_{t + 1} = {q}_{t} - Q , {b}_{t + 1} = {b}_{t} ,$$

i.e., the basis does not change, and a capital gain/loss of Q(p−bₜ) is generated. If Q shares are bought at a price p, the dynamics are

$${q}_{t + 1} = {q}_{t} + Q , {b}_{t + 1} = \frac{{q}_{t}}{{q}_{t} + Q} {b}_{t} + \frac{Q}{{q}_{t} + Q} p .$$

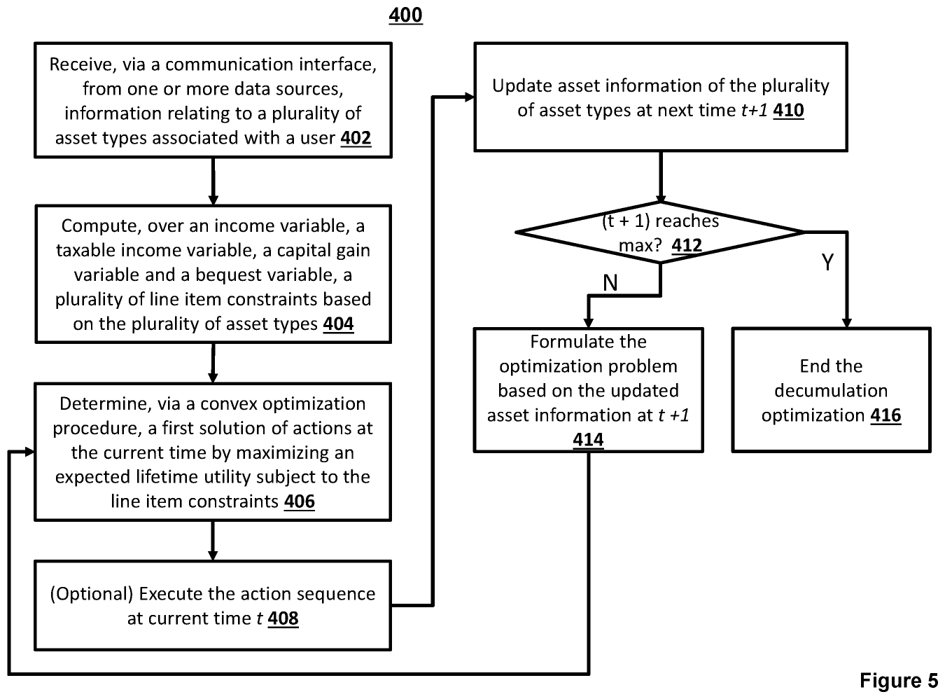

FIG. 5 is a simplified workflow diagram illustrating a method for generating a timeline-based asset portfolio decumulation plan, according to some embodiments described herein. One or more of the processes of process 500 may be implemented, at least in part, in the form of executable code stored on non-transitory, tangible, machine-readable media that when run by one or more processors may cause the one or more processors to perform one or more of the processes. In some embodiments, process 500 may be performed by the server 130 in FIGS. 2-3. It is worth noting that additional processes, steps and/or implementations may be omitted, performed in a different sequence, or combined as desired or appropriate.

At step 502, a communication interface may receive from one or more data sources (e.g., databases 119a-n in FIG. 2), information relating to a plurality of asset types associated with a user. The plurality of asset types include at least a first involuntary liability advantaged account (e.g., an HSA account, a Roth IRA account, etc.) and a deferred compensation account (e.g., a social security account, a retirement account, and/or the like).

At step 504, the system may compute, over an income variable, a taxable income variable, a capital gain variable and a bequest variable, a first line item constraint relating to the first liability advantaged account and a second line item constraint relating to the deferred compensation account. For example, the expected lifetime utility includes a consumption utility as a function of the consumption variable and a bequest utility as a function of the bequest variable weighted by a probability that decumulation happens at a future time given the user is alive at the current time. The first line item constraint includes at least a first constraint that a minimum required distribution of the account value divided by an expected lifespan from the current time is withdrawn when the user is older than a pre-defined age limit at a future time, and a second constraint that no additional amount is added to the first liability advantaged account when the user is older than the pre-defined age limit at the future time.

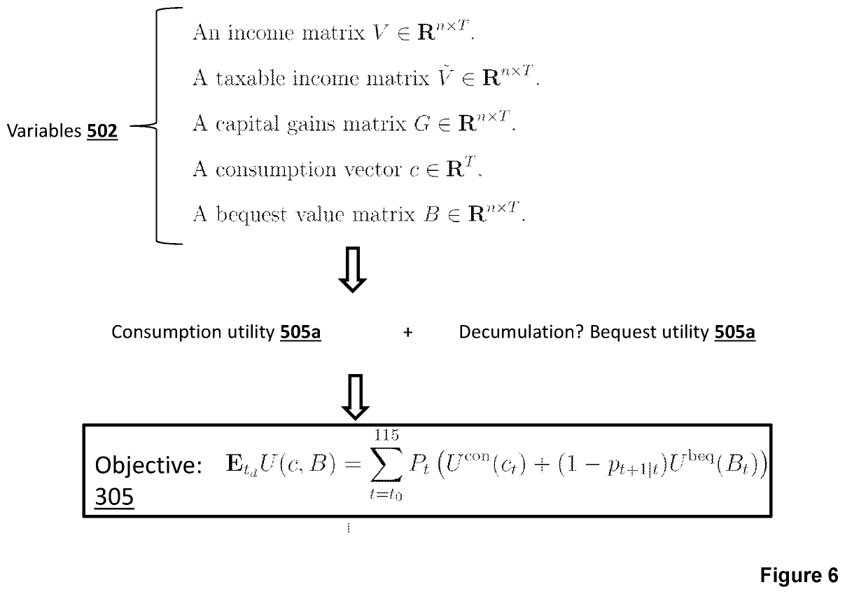

FIG. 6 provides an example diagram illustrating the example expected lifetime utility computed at step 504. For example, variables 602 such as an income matrix V∈R^{n×T}, a taxable income matrix \tilde{V}∈R^{n×T}, a capital gains matrix G∈R^{n×T}, a consumption vector c∈R^{T}, a bequest value matrix B∈R^{n×T}. All the above variables have units of real (i.e., inflation adjusted to t₀) dollars may be used to compute the consumption utility 605a and the bequest utility 605b, which is combined into the decumulation objective 305, as described in relation to FIG. 2.

Referring back to step 506 in FIG. 5, the system may determine, via a convex optimization procedure, a first solution of actions at the current time by maximizing an expected lifetime utility over a consumption variable and the bequest variable subject to the first line item constraint and the second line item constraint. For example, the system may receive a first value for the income variable and a second value for the taxable income variable and generates a consumption at a third value of the consumption variable. The system may then make a bequest at a fourth value of the bequest variable when the current time equals a decumulation time.

At step 508, the system may (optionally) execute the action sequence corresponding to the first solution of actions at current time t.

At step 510, asset information of the plurality of asset types may be updated for a next time t+1.

If the time t+1 has reached the maximum running time of the decumulation optimization, the decumulation optimization may be ended at step 516. Otherwise, if the time t+1 has not reached the maximum running time of the decumulation optimization, the system may formulate the optimization problem based on the updated asset information at time t+1. Process 500 may then repeat at step 506 to find a solution to the updated decumulation optimization problem at time t+1. In this way, the system may dynamically repeat the convex optimization procedure to compute a respective a solution of actions for a number of future times based on progressively updated information of the plurality of asset types over time.

In one implementation, the mass transport formulation may be adopted to formulate multi-asset portfolio construction. Let there be n assets. Let U^{(k)}∈R₊^{T×T} such that Uᵢⱼ^{(k)} is the total amount of asset k purchased in year i and sold in year j. h^{(k)}∈R₊^{T} such that hᵢ^{(k)} is the total amount of asset k that is purchased in year i and held forever. Assets cannot be sold before purchasing them, which means that Uᵢⱼ^{(k)}=0 for j<i.

The time series of gross purchase amounts for asset k is given by b^{(k)}=U^{(k)}1+h^{(k)}∈R^{T}. The time series of gross sell amounts for asset k is given by s^{(k)}=(R^{(k)}∘U^{(k)})^{T}1∈R^{T}, where R^{(k)}∈R^{T×T} is a constant matrix, such that Rᵢⱼ^{(k)} is the return on asset k purchased in year i and sold in year j. R^{(k)} is compared from data using the quantiles of historical returns, or risk adjusted returns. The net cash flow into the account is u=Σₖ₌₁ⁿb^{(k)}−s^{(k)}. Assuming the account is non-qualified, the time series of capital gains generated by the account is g=Σₖ₌₁ⁿ(G^{(k)}∘U^{(k)})^{T}1∈R^{T}, where

$${G}_{i j}^{( k )} = {R}_{i j}^{( k )} - 1 .$$

The nominal account value of asset k, as a function of time, is given by v^{(k)}∈R^{T}. Here vₜ^{(k)} the value of asset k in the account after buying and selling for time period t, which is is

$${v}_{t}^{( k )} = {\sum }_{i = 1}^{t} {R}_{i , t + 1}^{( k )} ( {h}_{i}^{( k )} + {\sum }_{j = t + 1}^{T} {U}_{i j}^{( k )} ) .$$

The bequest value is equal to the account value. The time series of income generated by asset k in the account is proportional to the account value, i.e., y^{(k)}=d^{(k)}∘v^{(k)}, where d^{(k)}∈R^{T} is the time series of dividend (i.e., income) yield for asset k. For unqualified accounts, the state is simply the current holdings. For qualified accounts, the state is the history of tax-lots purchased.

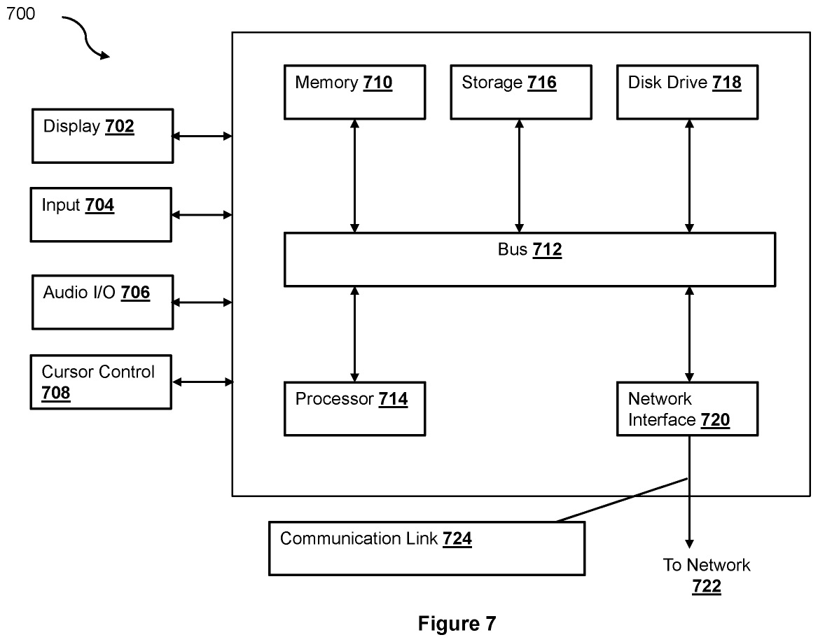

FIG. 7 is a block diagram of a computer system suitable for implementing one or more components shown in FIGS. 2-3 and performing one or more processes shown in FIGS. 4-6, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 700 in a manner as follows.

The computer system 700 includes a bus 712 or other communication mechanism for communicating information data, signals, and information between various components of the computer system 700. The components include an input/output (I/O) component 704 that processes a user (i.e., sender, recipient, service provider) action, such as selecting keys from a keypad/keyboard, selecting one or more buttons or links, etc., and sends a corresponding signal to the bus 712. The I/O component 704 may also include an output component, such as a display 702 and a cursor control 708 (such as a keyboard, keypad, mouse, etc.). The display 702 may be configured to present a login page for logging into a user account or a checkout page for purchasing an item from a merchant. An optional audio input/output component 706 may also be included to allow a user to use voice for inputting information by converting audio signals. The audio I/O component 706 may allow the user to hear audio. A transceiver or network interface 720 transmits and receives signals between the computer system 700 and other devices, such as another user device, a merchant server, or a service provider server via network 722. In one embodiment, the transmission is wireless, although other transmission mediums and methods may also be suitable. A processor 714, which can be a micro-controller, digital signal processor (DSP), or other processing component, processes these various signals, such as for display on the computer system 700 or transmission to other devices via a communication link 724. The processor 714 may also control transmission of information, such as cookies or IP addresses, to other devices.

The components of the computer system 700 also include a system memory component 710 (e.g., RAM), a static storage component 716 (e.g., ROM), and/or a disk drive 718 (e.g., a solid-state drive, a hard drive). The computer system 700 performs specific operations by the processor 714 and other components by executing one or more sequences of instructions contained in the system memory component 710. For example, the processor 714 can perform the position detection of webpage elements described herein according to the process 300.

Logic may be encoded in a computer readable medium, which may refer to any medium that participates in providing instructions to the processor 714 for execution. Such a medium may take many forms, including but not limited to, non-volatile media, volatile media, and transmission media. In various implementations, non-volatile media includes optical or magnetic disks, volatile media includes dynamic memory, such as the system memory component 710, and transmission media includes coaxial cables, copper wire, and fiber optics, including wires that comprise the bus 712. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 700. In various other embodiments of the present disclosure, a plurality of computer systems 700 coupled by the communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications.

1-20. (canceled)

21. A method for updating and displaying a timeline-based asset portfolio decumulation plan on a display device, the method comprising:
receiving, at a current time via a communication interface and over a communication network, from one or more data vendor servers, account information relating to a plurality of asset types associated with a user, wherein the plurality of asset types include at least a first involuntary liability advantaged account and a deferred compensation account;
storing, at one or more network-based storage devices, the received account information as data records;
translating, by a processor, the account information relating to the plurality of asset types into one or more line item constraints over an income variable, a taxable income variable, a capital gain variable and a bequest variable,
wherein the one or more line item constraints comprise a first line item constraint relating to the first liability advantaged account and a second line item constraint relating to the deferred compensation account, and
wherein each of the income variable, the taxable income variable, the capital gain variable and the bequest variable takes a form of a matrix having entries of real dollar values;
determining, by the processor running a convex optimization procedure, a first solution of actions for the current time by maximizing an expected lifetime utility over a consumption variable and the bequest variable subject to the first line item constraint and the second line item constraint, wherein the first solution of actions takes a form of a first sequence of actions for a first future period of time starting from the current time;
causing to be displayed at a user interface, via the communication interface and over the communication network, a first electronic message comprising the first solution of actions for the current time to a user device;
receiving and storing, at a next time after incrementing for current time by a time unit, updated account information relating to the plurality of asset types from the one or more data vendor servers;
dynamically repeating, by the processor, the convex optimization procedure including translating the updated information into updated line item constraints, thereby resulting in a second solution of actions for the next time based on the updated account information relating to the plurality of asset types, wherein the second solution of actions takes a form of a second sequence of actions for a second future period of time starting from the next time; and
causing to be displayed at the user interface, via the communication interface and over the communication network, a second electronic message comprising the second solution of actions reflecting progressively updated account information relating to the asset types over time to the user device for the next time.

22. The method of claim 21, wherein the expected lifetime utility includes a consumption utility as a function of the consumption variable and a bequest utility as a function of the bequest variable weighted by a probability that decumulation happens at a future time given the user is alive at the current time.

23. The method of claim 1, wherein the determined first solution of actions includes, for the current time:
receiving a first value for the income variable and a second value for the taxable income variable;
generating a consumption at a third value of the consumption variable; and
making a bequest at a fourth value of the bequest variable when the current time equals a decumulation time.

24. The method of claim 1, further comprising:
updating information relating to the plurality of asset types associated with the user with actual values of the income variable, the taxable income variable, the capital gain variable, the bequest variable and the consumption variable for the current time; and
repeating the convex optimization procedure with the updated information for the second solution of actions for the next time.

25. The method of claim 24, further comprising:
dynamically repeating the convex optimization procedure to compute a respective a solution of actions for a number of future times based on progressively updated information of the plurality of asset types over time.

26. The method of claim 21, wherein the first line item constraint includes at least a first constraint that a minimum required distribution of the account value divided by an expected lifespan from the current time is withdrawn when the user is older than a pre-defined age limit at a future time, and a second constraint that no additional amount is added to the first liability advantaged account when the user is older than the pre-defined age limit at the future time.

27. The method of claim 21, wherein the second line item constraint takes a form that the taxable income variable equals the income variable times a pre-defined annual income deferral ratio.

28. The method of claim 21, further comprising:
computing a third line item constraint relating to annuity purchase by:
computing the income variable for the current time based on an amount of annuity payment purchased and an inflation rate; and
computing the taxable income variable based on an exclusion ratio of the annuity purchased and the computed income variable.

29. The method of claim 1, wherein the plurality of asset types include a health savings account, and the method further comprises:
computing a third line item constraint relating to the health savings account by:
computing the taxable income variable as a difference between the income variable and a known qualified medical expense for the current time; and
computing the bequest variable as a fixed portion of an account value of the health savings account.

30. The method of claim 9, wherein the plurality of asset types further include a trust account, and the method further comprises:
computing a fourth line item constraint relating to the trust account that defines a relationship between the income variable and a gift amount in excess of a pre-defined gift amount limit deplete the lifetime gift exemption for the current time.

31. The method of claim 10, wherein the plurality of asset types further include a taxable investment account, and the method further comprises:
computing a fifth line item constraint relating to the taxable investment account based on a purchase amount, an amount sold and a fixed return on a purchase lot or a sell lot for the current time.

32. The method of claim 8, further comprising:
computing a fourth line item constraint relating to claiming the deferred compensation account by:
selecting a first convex combination of cash flows of claiming at different claiming times; and
designating the income variable for the current time as the selected convex combination.

33. The method of claim 32, wherein the fourth line item constraint further includes a spousal benefit constraint that includes a spousal benefit as a second convex combination of cash flows of claiming benefit at different claiming times.

34. The method of claim 32, further comprising:
computing a fifth line item constraint relating to a real estate asset based on a rental income, an inflation rate and a time-varying asset value inflated with the inflation rate.

35. The method of claim 34, further comprising:
computing a sixth line item constraint relating to a mortgage based on dynamics of a principal balance of the mortgage and an annual mortgage payment amount.

36. A system for updating and displaying a timeline-based asset portfolio decumulation plan on a display device, the system comprising:
a communication interface that receiving, at a current time via a communication interface and over a communication network, from one or more data vendor servers, account information relating to a plurality of asset types associated with a user, wherein the plurality of asset types include at least a first involuntary liability advantaged account and a deferred compensation account; and
a processor that executes instructions from a memory to perform operations comprising:
storing, at one or more network-based storage devices, the received account information as data records;
translating, by a processor, the account information relating to the plurality of asset types into one or more line item constraints over an income variable, a taxable income variable, a capital gain variable and a bequest variable,
wherein the one or more line item constraints comprise a first line item constraint relating to the first liability advantaged account and a second line item constraint relating to the deferred compensation account, and
wherein each of the income variable, the taxable income variable, the capital gain variable and the bequest variable takes a form of a matrix having entries of real dollar values;
determining, by the processor running a convex optimization procedure, a first solution of actions for the current time by maximizing an expected lifetime utility over a consumption variable and the bequest variable subject to the first line item constraint and the second line item constraint, wherein the first solution of actions takes a form of a first sequence of actions for a first future period of time starting from the current time; and
a user interface device that causes to be displayed, via the communication interface and over the communication network, a first electronic message comprising the first solution of actions for the current time to a user device;
wherein the operations further comprise: receiving and storing, at a next time after incrementing the current time by a time unit, updated account information relating to the plurality of asset types from the one or more data vendor servers, and
dynamically repeating, by the processor, the convex optimization procedure including translating the updated information into updated line item constraints, thereby resulting in a second solution of actions for the next time based on the updated account information relating to the plurality of asset types, wherein the second solution of actions takes a form of a second sequence of actions for a second future period of time starting from the next time,
wherein the user interface device further causes to be displayed over the communication network, a second electronic message comprising the second solution of actions reflecting progressively updated account information relating to the asset types over time to the user device for the next time.

37. The system of claim 36, wherein the operations further comprise:
updating information relating to the plurality of asset types associated with the user with actual values of the income variable, the taxable income variable, the capital gain variable, the bequest variable and the consumption variable for the current time; and
repeating the convex optimization procedure with the updated information for the second solution of actions for the next time.

38. The system of claim 37, further comprising:
dynamically repeating the convex optimization procedure to compute a respective a solution of actions for a number of future times based on progressively updated information of the plurality of asset types over time.

39. A processor-readable storage non-transitory medium storing a plurality of processor-executable instructions for updating and displaying a timeline-based asset portfolio decumulation plan on a display device, the processor-executable instructions being executed by a processor to perform operations comprising:
receiving, at a current time via a communication interface and over a communication network, from one or more data vendor servers, account information relating to a plurality of asset types associated with a user, wherein the plurality of asset types include at least a first involuntary liability advantaged account and a deferred compensation account;
storing, at one or more network-based storage devices, the received account information as data records;
translating, by a processor, the account information relating to the plurality of asset types into one or more line item constraints over an income variable, a taxable income variable, a capital gain variable and a bequest variable,
wherein the one or more line item constraints comprise a first line item constraint relating to the first liability advantaged account and a second line item constraint relating to the deferred compensation account, and
wherein each of the income variable, the taxable income variable, the capital gain variable and the bequest variable takes a form of a matrix having entries of real dollar values;
determining, by the processor running a convex optimization procedure, a first solution of actions for the current time by maximizing an expected lifetime utility over a consumption variable and the bequest variable subject to the first line item constraint and the second line item constraint, wherein the first solution of actions takes a form of a first sequence of actions for a first future period of time starting from the current time;
causing to be displayed at a user interface, via the communication interface and over the communication network, a first electronic message comprising the first solution of actions for the current time to a user device;
receiving and storing, at a next time after incrementing the current time by a time unit, updated account information relating to the plurality of asset types from the one or more data vendor servers;
dynamically repeating, by the processor, the convex optimization procedure including translating the updated information into updated line item constraints, thereby resulting in a second solution of actions for the next time based on the updated account information relating to the plurality of asset types, wherein the second solution of actions takes a form of a second sequence of actions for a second future period of time starting from the next time; and
causing to be displayed at a user interface, via the communication interface and over the communication network, a second electronic message comprising the second solution of actions reflecting progressively updated account information relating to the asset types over time to the user device for the next time.

40. The processor-readable storage non-transitory medium of claim 39, wherein the operations further comprise:
updating information relating to the plurality of asset types associated with the user with actual values of the income variable, the taxable income variable, the capital gain variable, the bequest variable and the consumption variable for the current time;
repeating the convex optimization procedure with the updated information for the second solution of actions for the next time; and
dynamically repeating the convex optimization procedure to compute a respective a solution of actions for a number of future times based on progressively updated information of the plurality of asset types over time.
